(19) United States
(12) Patent Application Publication
(10) Pub. No.: US 2009/0273796 A1
(43) Pub. Date: Nov. 5, 2009

(54) PEELING IMAGED MEDIA FROM A SUBSTRATE

(75) Inventors: Ian M. Garben, Burnaby (CA); Paul Holt, Surrey (CA); Frank S. Principe, Landenberg, PA (US); Edmund Francis Schieffer, JR., Wilmington, DE (US); Steven M. Fisher, West Chester, PA (US); Charles L. Spyres, Newark, DE (US)

Correspondence Address: EASTMAN KODAK COMPANY;PATENT LEGAL STAFF, 343 STATE STREET, ROCHESTER, NY, 14650-2201, US

(73) Assignee: Kodak Graphic Communications Canada Company, Burnaby (CA)

(21) Appl. No.: 12/238,625

(22) Filed: Sep. 26, 2008

Related U.S. Application Data
(60) Provisional application No. 61/049,423, filed on Apr. 30, 2008.

(51) Int. Cl. G06K 15/22

(52) U.S. Cl. 358/1.4

(57) ABSTRACT

A method for imaging a media is provided which includes supporting a substrate and the media in a layered configuration. An imaging head is operated to image the media by directing radiation beams towards a surface of the imaged media while effecting relative movement between the imaging head and the support. A roller is brought into contact with the imaged media. The roller can be brought into contact with an un-imaged region of the surface of the imaged media, the un-imaged region corresponding to a region of the surface of the imaged media that is not impinged by the radiation beams. The un-imaged region could be an edge portion of the media. Relative movement is effected between an axis of rotation of the roller and the support to cause the roller to roll on the regions of the surface of the imaged media impinged by the radiation beams.

### RELATED APPLICATIONS

This application claims the benefit of U.S. Provisional Application No. 61/049,523 filed May 1, 2008 and U.S. application Ser. No. 11/975,418 filed Oct. 17, 2007.

### FIELD OF THE INVENTION

This invention relates to methods and apparatus for peeling or otherwise removing media from substrates. Particular embodiments of this invention are provided in imaging machines, where media incorporating donor material are imaged to impart donor material onto substrates and, after imaging, are removed from the substrates.

### BACKGROUND OF THE INVENTION

Color displays, such as liquid crystal displays and the like, typically incorporate color filters used to provide pixels with color. One technique for fabricating color filters involves a laser-induced thermal transfer process. A particular prior art thermal transfer process is illustrated schematically in FIG. 1A. A substrate 10 (often referred to as a “receiver element”) is overlaid with a donor element 12 (often referred to as a “donor sheet”). In the case of color filter fabrication, substrate 10 is typically made of glass and has a generally planar shape. Donor element 12 is typically a sheet which is relatively thin and relatively flexible when compared to substrate 10. Donor element 12 may be made of plastic, for example. Donor element 12 incorporates donor material (not shown). The donor material may comprise a colorant, a pigment or the like used to fabricate the color filter.

Donor element 12 is image-wise exposed to selectively transfer donor material from donor element 12 to substrate 10. Some exposure methods involve controlling a radiation source to emit radiation beams. For example, as shown in FIG. 1A, one or more controllable lasers 14 are employed to provide one or more corresponding laser beams 16. In currently preferred techniques, laser beam(s) 16 induce the transfer of donor material from the imaged regions of donor element 12 to corresponding regions of substrate 10. Controllable laser(s) 14 may comprise diode laser(s) which are relatively easy to modulate, have relatively low cost and have relatively small size. Such laser(s) 14 are controllable to directly image-wise expose donor element 12. In some embodiments, masks (not shown) are used to image-wise expose donor element 12.

Once the donor material has been image-wise transferred from donor element 12 to substrate 10, it is typically necessary to remove the imaged donor element 12 from substrate 10. For example, during the fabrication of color filters, a first donor element 12 may be used to apply red colorant to substrate 10, a second donor element 12 may be used to apply green colorant and a third donor element 12 may be used to apply blue colorant. After use, a given imaged donor element 12 is removed from substrate 10 prior to application and use of a subsequent donor element 12.

In various prior art techniques, donor element 12 is removed from substrate 10 using a roller 18 incorporating one or more suction features 20. Roller 18 is brought into proximity of edge 12A of donor element 12 (as shown by arrow 19) and then suction is applied through suction features 20, such that edge 12A of donor element 12 is secured to suction features 20. Roller 18 is then rotated (as shown by arrow 22) and translated (as shown by arrow 24) to wind donor element 12 off of substrate 10 and onto the circumferential surface 18A of roller 18 to thereby peel donor element 12 from substrate 10.

In some cases, during the removal process some donor material corresponding to the exposed regions of donor element 12 may remain partially adhered to donor element 12 rather than adhering to substrate 10 as intended. Partial adherence of the donor material to donor element 12 can make it difficult to remove donor element 12 from substrate 10. In some cases removal of a donor element 12 from substrate 10 can result in an irregular separation between some of the donor material that has been transferred to substrate 10 and some of the donor material that has remained attached to donor element 12. For example, FIG. 1B shows a portion of donor element 12 positioned on top of substrate 10. A region of the donor element 12 has been exposed to form an imaged region 25. Imaged region 25 is separated from non-imaged region 27 by imaged edge 25A. However, rather than separating cleanly at imaged edge 25A during the removal of donor element 12 from substrate 10, separation can occur within a larger zone within imaged region 25 in the vicinity of imaged edge 25A. As shown in FIG. 1C, after donor element 12 is removed, donor material may not remain evenly distributed along a region of substrate 10 corresponding to imaged edge 25A. Rather, the amount of donor material that remains transferred to this region can be less than desired and the distribution of the transferred donor element along this region can be uneven. This can lead to the formation an edge 25B which includes fractures and other various discontinuities. These fractured edges can result in objectionable visual artifacts in the final image. In addition, donor material can also extend into non-imaged region 27, which is also undesirable.

There is a general desire to provide methods and apparatus for more effectively removing imaged media from a substrate.

There is a general desire to provide methods and apparatus for more effectively removing a donor element from a substrate after donor material has been transferred from the donor element to the substrate.

### SUMMARY OF THE INVENTION

The present invention relates to a method for imaging a media. The media is placed on a support which supports a substrate and the media in a layered configuration. An imaging head is operated to image the media by directing radiation beams towards a surface of the imaged media while effecting relative movement between the imaging head and the support. A roller, such as, for example, an idler roller, is brought into contact with the imaged media. The roller can be brought into contact with an un-imaged region of the surface of the imaged media, the un-imaged region corresponding to a region of the surface of the imaged media that is not impinged by the radiation beams. The un-imaged region could be an edge portion of the media.

The roller is rotatable about an axis of rotation. Relative movement is effected between the axis of rotation of the roller and the support to cause the roller to roll along a rolling direction on the regions of the surface of the imaged media impinged by the radiation beams. The roller can be caused to roll on the surface of the imaged media along a direction that leads away from the edge portion. The imaged media is then removed from the substrate. In one embodiment, the imaged media can be removed by wrapping a portion of the imaged media over a portion of a cylindrical surface of the roller while peeling the imaged media from the substrate. The peeling direction can be in the same direction as, or an opposite direction to, the rolling direction. In one embodiment, the rolling direction can be, but is not necessarily, parallel to the scan direction, a conveyance direction of the support or a direction of a stripe feature formed on the substrate.

After the imaged media is removed from the substrate, an additional media can be placed on the substrate on the support in layered configuration. The additional media can be imaged while effecting relative movement between the imaging head and the support. The imaged additional media can then be removed from the substrate while effecting relative movement between the axis of rotation of the roller and the support.

In one embodiment, a take up roller can be used to spool a portion of the imaged media while not rolling the take-up roller on the surface of the media. A portion of the imaged media can be spooled onto the take-up roller while removing the imaged media from the substrate.

In one embodiment, a brake, such as, for example, a magnetic particle brake or other suitable brake is used to selectively apply drag to the roller while rolling the roller on a portion of the surface of the imaged media.

In another embodiment, a method for imaging a media includes providing a support for supporting a substrate and the media in a layered configuration. An imaging head is operated to emit radiation beams towards the media to image the media while the media and the substrate are in the layered configuration. A roller is brought into contact with a surface of the imaged media. Drag, such as, for example, rotational drag, is selectively applied to the roller while rolling the roller on the surface of the imaged media. The drag can be applied with a brake or can be applied by activating an actuator. The imaged media is removed from the substrate. The roller can be rolled on the surface of the imaged media prior to, or at the same time as, the imaged media is peeled from the substrate.

In one embodiment, the roller can be rolled along a plurality of different directions on the surface of the imaged media and the drag can be selectively applied in different amounts, at different times, to the roller as the roller is rolled on the surface along each of the directions. The roller can be rolled on the surface of the imaged media while maintaining the imaged media and the substrate in the layered configuration. The roller can be rolled on the surface of the imaged media while peeling the media from the substrate. A contact roller can roll on the surface imaged media and a portion of the imaged media can be wrapped over a portion of a surface of the contact roller while peeling the imaged media from the substrate. A take-up roller can be used to spool a portion of the imaged media while not rolling the take-up roller on the surface of the imaged media. The portion of the imaged media can be spooled onto the take-up roller while peeling the imaged media from the substrate.

In another embodiment, a substrate is supported on a support. A donor element is positioned on the substrate after supporting the substrate on the support. An imaging head is operated to image the donor element by directing radiation beams towards the donor element. A roller, which is rotatable about an axis of rotation, is brought into contact with a surface of the imaged donor element. A plurality of relative movements are effected between the axis of rotation of the roller and the imaged donor element to cause the roller to roll on one or more imaged regions of the imaged donor element a plurality of times. The roller can be rolled in the same direction or different directions each time it is rolled on the one or more imaged regions.

Differing amounts of drag can be applied, with a brake or other device, to the roller as roller rolls on the one or more imaged regions of the imaged donor element during one relative movement between the axis of rotation of the roller and the imaged donor element than during another relative movement between the axis of rotation of the roller and the imaged donor element.

The imaged donor element is removed from the substrate during a relative movement between the axis of rotation of the roller and the imaged donor element. The substrate is removed from the support after the imaged donor element is removed from the substrate. The substrate is not removed from the support during any relative movement of the plurality of relative movements between the axis of rotation of the roller and the imaged donor element.

After the imaged donor element is removed from the substrate, a second donor element can be positioned on the substrate and imaged. The second donor element can be removed from the substrate while effecting relative movement between the axis of rotation of the roller and the imaged second donor element.

Rolling the roller on the region of the imaged donor element reduces edge discontinuities along the edge of the feature when the donor element is peeled from the substrate. By using a brake adapted to increase the amount of drag applied to the roller when the roller is rolled on the region of the imaged donor element, an amount of the donor material that remains transferred to the surface of the substrate when the imaged donor element is peeled from the substrate is adjusted.

In another embodiment, an apparatus for imaging media is provided which includes a support adapted to support a substrate and the media in a layered configuration. An imaging head is adapted to emit radiation beams towards the media to image the media. A roller is provided and a brake is adapted to selectively apply drag to the roller. A chassis supports the roller such that the roller is rotatable relative to the chassis. A controller, which can include one or more controllers, is configured to operate the imaging head to emit the radiation beams towards the media. The controller effects relative movement between the chassis and the support to bring the roller in the vicinity of the imaged media while the imaged media and the substrate are in the layered configuration. The controller also effects a plurality of relative movements between the chassis and the support to cause the roller to roll on a surface of the imaged media a plurality of times. In addition, the controller can control the brake to selectively vary the drag applied to the roller between one relative movement between the chassis and the support and another relative movement between the chassis and the support.

### BRIEF DESCRIPTION OF THE DRAWINGS

FIG. 1A shows a prior art thermal transfer process in which an imaged donor element is peeled from a substrate;

FIGS. 1B and 1C shows the formation of edge discontinuities when an imaged donor element is conventionally peeled from a substrate;

FIG. 2A schematically shows a plan view of an image forming system according to an example embodiment of the invention;

FIG. 2B schematically shows a partial cross-sectional view of the imaging system of FIG. 2A;

FIG. 2C schematically shows rolling a contact roller on an imaged donor element prior to the removal of the imaged donor element from a substrate as per an example embodiment of the invention;

FIGS. 2D, 2E and 2F schematically show a series of operations employed by a sheet removal apparatus to remove the donor element of FIG. 2C as per an example embodiment of the invention;

FIG. 3 shows a flow chart representing method according to an example embodiment of the invention; and

FIG. 4 shows a schematic force diagram representing the motion of a contact roller as it rolls on an imaged donor element supported by a substrate.

### DETAILED DESCRIPTION OF THE INVENTION

Throughout the following description specific details are presented to provide a more thorough understanding to persons skilled in the art. However, well-known elements may not have been shown or described in detail to avoid unnecessarily obscuring the disclosure. Accordingly, the description and drawings are to be regarded in an illustrative, rather than a restrictive, sense. Additionally, the drawings may not be necessarily to scale, and portions thereof may be exaggerated for clarity.

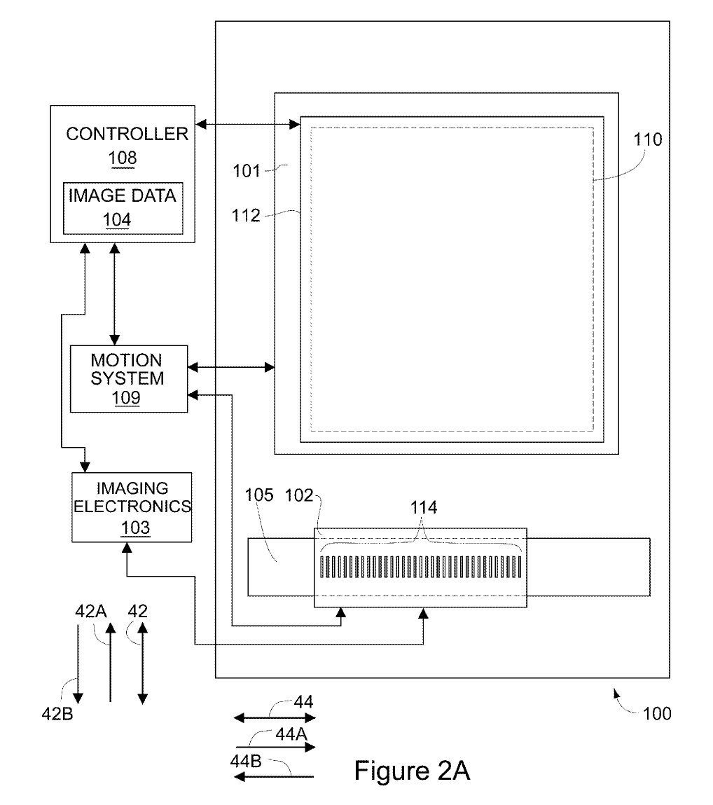

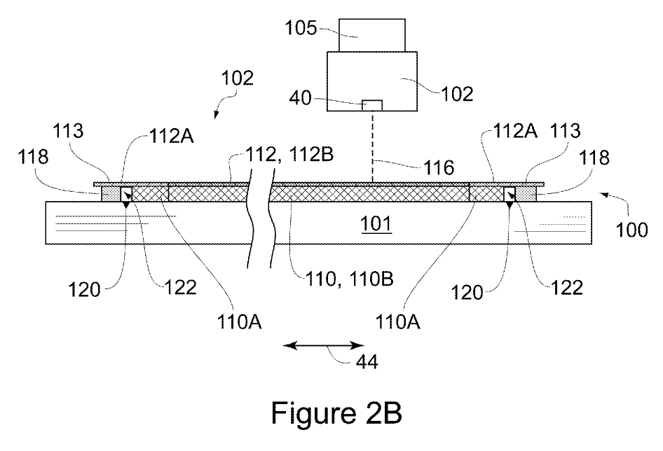

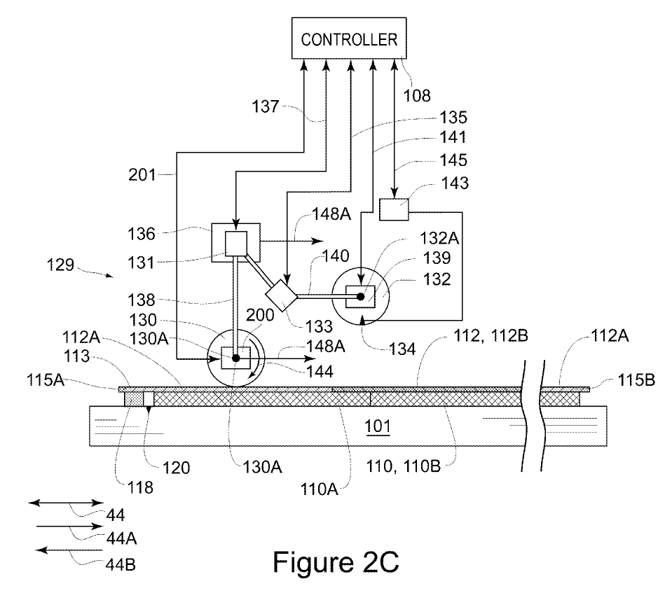

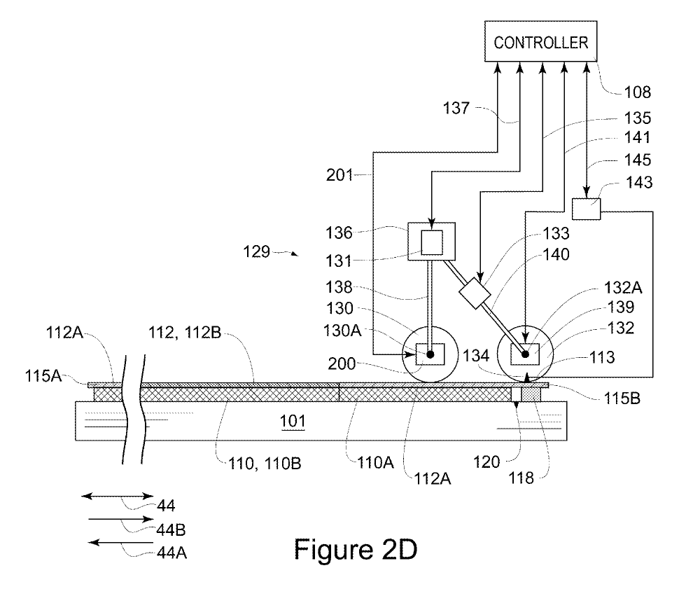

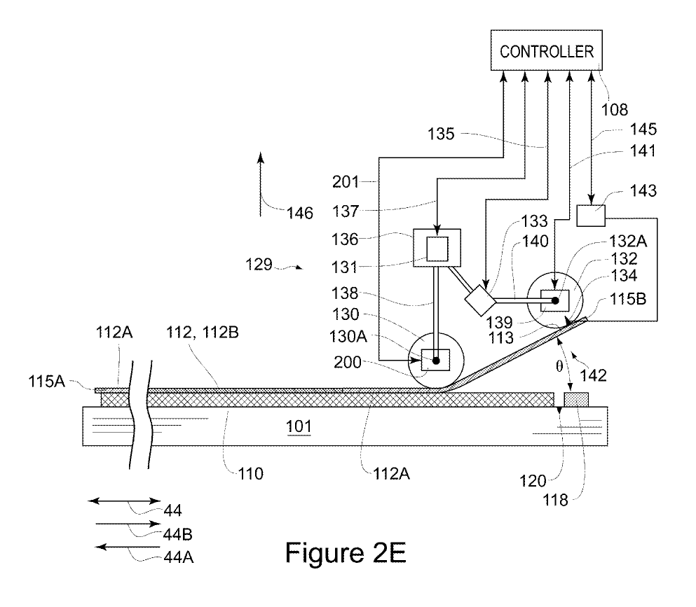

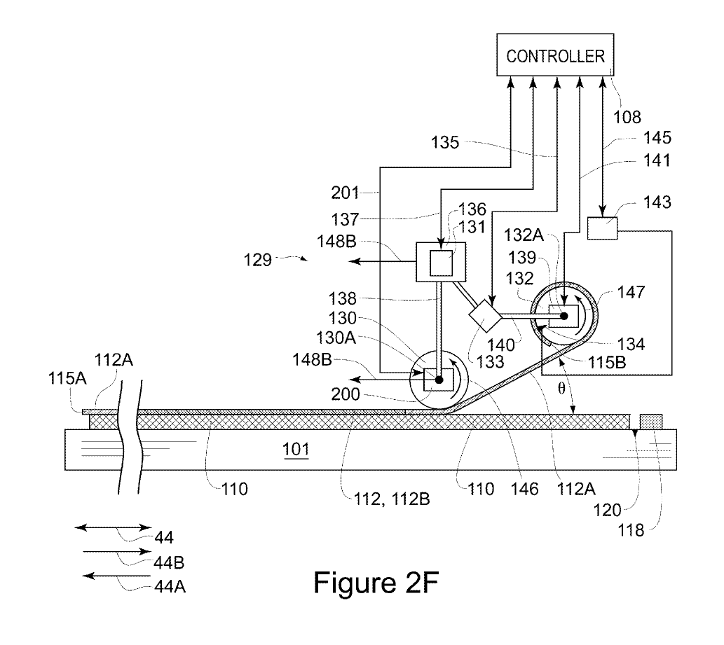

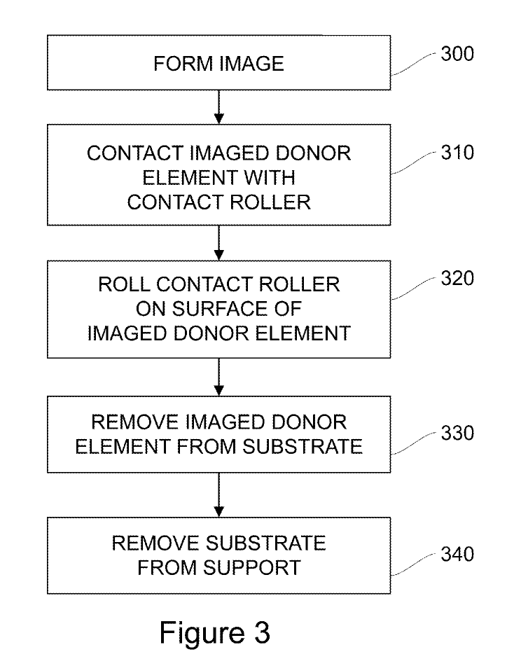

FIG. 3 shows a flow chart representative of a method for removing an imaged media that is supported on a substrate as per an example embodiment of the invention. The various steps illustrated in FIG. 3 are described with reference to an apparatus 100, portions of which are shown in FIGS. 2A-2F according to an example embodiment of the invention. This is for the purpose of illustration only and other suitable image forming apparatus can be used with the present invention. In step 300, the media is processed to form an image. In this example embodiment the image is formed by imaging techniques (i.e. also known as exposure techniques). Imaging techniques can employ beams of radiation (e.g. laser beams) to form an image on a surface. These images can be formed in various ways. For example, imaging techniques can be used to change a property or characteristic of an image modifiable layer to form an image thereon. Imaging techniques can be used to ablate a surface to form an image thereon. Imaging techniques can be used to facilitate a transfer of donor material to a surface to form an image thereon.

In this illustrated embodiment, by way of example only, a thermal transfer process is employed and the media includes donor element 112. An imaging head 102 comprising a radiation source (not shown) such as a laser is provided to transfer donor material (also not shown) from a donor element 112 to a surface of substrate 110 (shown in broken lines in FIG. 2A). Imaging head 102 can include one or more channels 114. In this illustrated embodiment, imaging head 102 includes an arrangement of channels 114; each of the channels 114 being individually controllable to emit radiation beams 116 (not shown in FIG. 2A). Imaging head 102 is operated to direct the radiation beams 116 to impinge on various regions of donor element 112. Imaging electronics 103 control the emission of radiation beams 116 from channels 102 in accordance with image data 104 provided by controller 108.

In this illustrated embodiment, substrate 110, imaging head 102, or a combination of both, are moved relative to one another while channels 114 are controlled in response to image data 104 to scan the radiation beams 116 over donor element 112 in an image-wise fashion. In some cases, imaging head 102 is stationary and substrate 110 is moved. In other cases, substrate 110 is stationary and imaging head 102 is moved. In still other cases, both the imaging head 102 and substrate 110 are moved. In some example embodiments of the invention, imaging head 102 exposes donor 112 in a step and repeat fashion. In these embodiments, relative movement between imaging head 102 and donor element 112 can occur between shots of exposure. In some cases, donor element 112 can be too large to be imaged within a single exposure or scan. Multiple exposures or scans of imaging head 102 can be required to complete an image.

Any suitable mechanism may be applied to move imaging head 102 relative to substrate 110. Flat bed marking systems are typically used for forming images on surfaces comprising a substantially flat orientation. U.S. Pat. No. 6,957,773 to Gelbart describes a high-speed flatbed imager suitable for display panel exposure. In some example embodiments, suitably flexible substrates can be secured to either an external or internal surface of a “drum-type” support to affect the forming of images on the display assemblies.

FIG. 2A shows a schematic plan view of the image forming systems of apparatus 100. In FIG. 2A, a support 101 is provided for supporting substrate 110 and donor element 112 in a layered configuration. In this illustrated embodiment, support 101 is adapted to convey substrate 110 and donor element 112 along a path aligned with main-scan axis 42. In this embodiment, support 101 is movable along a plurality of conveyance directions (i.e. forward direction 42A and reverse direction 42B). Forward direction 42A is opposite to reverse direction 42B. Support 101 can reciprocate between forward direction 42A and reverse direction 42B. Imaging head 102 is movably supported on support 105 which straddles support 101. In this example embodiment, imaging head 102 is movable along a path aligned with sub-scan axis 44. In this embodiment, imaging head 102 can move along away direction 44A and along home direction 44B. Away direction 44A is opposite to home direction 44B. In this illustrated embodiment, imaging head 102 can bi-directionally scan radiation beams 116 over donor element 112 to form an image. Bidirectional scanning techniques can enhance imaging productivity since scans can be made in each of the opposing scan directions.

Motion system 109 is provided to cause the motion of support 101 and/or imaging head 102 and can include suitable drives, transmission members and/or guide members. Motion system 109 can include one or more motion systems. Those skilled in the art will realize that separate motion systems can also be used to operate different systems within apparatus 100.

Controller 108, which can include one or more controllers is used to control one or more systems of apparatus 100, including but not limited to, motion system 109. Controller 108 can cause image data 104 to be transferred to imaging head 102 and control the imaging head to emit radiation beams 116 in accordance with this data. Controller 108 may also control systems other than apparatus 100. Controller 108 may be configured to execute suitable software and may include one or more data processors, together with suitable hardware, including by way of non-limiting example: accessible memory, logic circuitry, drivers, amplifiers, A/D and D/A converters, input/output ports and the like. Controller 108 may comprise, without limitation, a microprocessor, a computer-on-a-chip, the CPU of a computer or any other suitable microcontroller. Controller 108 can be associated with a materials handling system.

FIG. 2B shows a schematic partial cross-sectional view of the image forming systems of apparatus 100. In the illustrated thermal transfer process, substrate 110 can be secured to support 101 by a variety of techniques known in the art (e.g. suction). In this illustrated embodiment, donor element 112 is positioned in a layered configuration with substrate 110 in which donor element 112 is laid on substrate 110 after substrate 110 is supported on support 101. To preserve image quality, it is desirable that donor element 112 be prevented from moving with respect to substrate 110 during imaging. As shown in FIG. 2B, support 101 comprises stands 118 which are transversely spaced apart from the edges of substrate 110 and which have heights that are substantially similar to the thickness of substrate 110. Support 101 also comprises one or more suction features 120 which apply suction in the spaces 122 between stands 118 and substrate 110. This suction secures donor element 112 to substrate 110. It will be appreciated by those skilled in the art that there are other additional and/or alternative techniques for securing donor element 112 to substrate 110 and the invention should be understood to accommodate such additional and/or alternative donor element securing techniques.

The transfer of donor material from donor element 112 to substrate 110 may be implemented using a variety of laser-induced thermal transfer techniques, for example. Examples of laser-induced thermal transfer processes used by the invention include: laser-induced “dye transfer” processes, laser-induced “melt transfer” processes, laser-induced “ablation transfer” processes, and laser-induced “mass transfer” processes.

In general, the make-up of substrate 110, donor element 112, and the donor material depend on the particular imaging application. In particular embodiments, imaging apparatus 100 is used to fabricate color filters for displays on substrate 110. In such embodiments, substrate 110 is typically made of a transparent material (e.g. glass), donor element 112 is typically made of plastic and the donor material typically comprises one or more colorants. Such colorants may include suitable dye-based or pigment-based compositions, for example. The donor material may also comprise one or more suitable binder materials.

In the illustrated embodiment, imaging head 102 is constrained to emit radiation beams 116 such that they impinge various areas of imaged region 112B of donor element 112. Consequently, region 112A of donor element 112 remains as a non-imaged area, and may in some cases provide a border around imaged region 112B. Accordingly, in the illustrated embodiment, donor material is only transferred from donor element 112 onto imaged region 110B of substrate 110 and not onto the non-imaged region 110A of substrate 110. In the illustrated embodiment, portions 113 of non-imaged region 112A overhang substrate 110 and are supported by stands 118.

At the conclusion of the imaging process, donor element 112 is removed from substrate 110. In this example embodiment, it is desired that donor element 112 be removed from substrate 110 in a manner that reduces the presence of fractures and other discontinuities at the edges of various features that are formed on substrate 110.

FIG. 2C is a schematic partial side view depicting one end of support 101, substrate 110 and imaged donor element 112. The removal of imaged donor element 112 from substrate 110 is effected by sheet removal apparatus 129 that in this illustrated embodiment forms part of apparatus 100. In the illustrated embodiment, sheet removal apparatus 129 comprises a chassis 136 and a plurality of rollers (i.e. contact roller 130 and take-up roller 132) which are mechanically coupled to chassis 136 by a corresponding pair of roller couplings (contact roller coupling 138 and take-up roller coupling 140).

Rollers 130, 132 are preferably substantially cylindrical in shape. Contact roller coupling 138 and take-up roller coupling 140 permit their respective rollers 130, 132 to rotate about their corresponding rotation axes 130A, 132A. In the illustrated embodiment, take-up roller coupling 140 comprises an actuator 133 which effects movement of the axis 132A of take-up roller 132 with respect to chassis 136. Actuator 133 is referred to herein as the “take-up roller axis-position actuator 133”. Take-up roller axis-position actuator 133 may be controlled by controller 108 using signal 135. Take-up roller axis-position actuator 133 may generally comprise any suitably coupled actuator. Non-limiting examples of actuators which may be used to provide take-up roller axis-position actuator 133 include suitably coupled electric motors and/or pneumatic actuators.

In the illustrated embodiment, take-up roller coupling 140 also comprises a take-up roller rotational actuator 139 which causes rotation of take-up roller 132 about its axis 132A. Take-up roller rotational actuator 139 may be controlled by controller 108 using signal 141. Preferably, take-up roller rotational actuator 139 comprises a suitably coupled motor, but take-up roller rotational actuator 139 may generally comprise any suitably configured actuator.

In the illustrated embodiment, take-up roller 132 also comprises one or more suction features 134. Suction features 134 may comprise orifices coupled in fluid communication to a source of suction 143. As is known in the art, suction source 143 may comprise a mechanism for creating a positive or negative pressure differential, such as a suitably configured pump or the like. Suction source 143 may be controlled by controller 108 using signal 145 which may also control one or more valves or similar components (not shown) related to the application of suction by suction source 143.

In the illustrated embodiment, contact roller 130 is a non-driven “idler” roller. In alternative embodiments, contact roller 130 may be rotationally driven. Sheet removal apparatus 129 also comprises one or more chassis-position actuators 131 which cause relative movement between support 101 and chassis 136. Relative movement between support 101 and chassis 136, results in corresponding movement between support 101 and rollers 130 and 132. In the illustrated embodiment, chassis-position actuators 131 cause movement of chassis 136 relative to support 101 to effect relative movement between support 101 and chassis 136. In other embodiments, chassis-position actuators 131 cause movement of support 101 relative to chassis 136 to effect relative movement between support 101 and chassis 136. Chassis-position actuators 131 may generally comprise any one or more suitably coupled actuators. Non-limiting examples of actuators which may be used to provide chassis-position actuators 131 include, suitably coupled electric motors and/or pneumatic actuators.

When it is desired to remove imaged donor element 112 from substrate 110, controller 108 uses signal to cause chassis-position actuators 131 to create relative movement between chassis 136 and support 101, such that chassis 136 and the rest of sheet removal apparatus 129 are positioned in the vicinity of one edge portion 115A of donor element 112 (see FIG. 2C). In the illustrated embodiment, sheet removal apparatus 129 approaches donor element 112 from a vertical direction. In other embodiments, chassis-position actuators 131 cause sheet removal apparatus 129 to approach donor element 112 (or donor element 112 to approach sheet removal apparatus 129) from other directions. In step 310, sheet removal apparatus 129 moves toward donor element 112 until contact roller 130 makes contact with donor element 112. Preferably, contact roller 130 contacts donor element 112 in non-imaged region 112A (i.e. outside of imaged region 112B). This positioning of the contact between contact roller 130 and donor sheet 112, while not essential to the invention, avoids an impact of contact roller 130 in imaged region 112B of donor element 112 and prevents any corresponding degradation of the image in corresponding imaged region 110B of substrate 110 that can result from such an impact. In this illustrated embodiment, take-up roller 132 has not been brought into contact with donor element 112. In this example, take-up roller axis-position actuator 133 is controlled to cause take-up roller 132 to not contact donor element 112.

In step 320, contact roller 130 is rolled on the surface of a portion of imaged donor element 112. In this example embodiment, contact roller 130 is rolled on a portion of imaged donor element 112 that includes imaged region 112B. In this illustrated embodiment of the invention, contact roller 130 is rolled on the regions of donor element 112 that were impinged by radiation beams during step 300. In this example embodiment, contact roller 130 is rolled along a path that extends from non-imaged region 112A in the vicinity of the edge portion 115A over imaged region 112B to non-imaged region 112A in the vicinity of edge portion 115B. Controller 108 uses signal 137 to cause chassis-position actuators 131 to move chassis 136 (including rollers 130, 132) along a rolling direction (as shown by arrow 148A) to cause contact roller 130 to roll on the supported donor element 112. In this illustrated embodiment, contact roller 130 rotates (as shown by arrow 144) as it is rolled on imaged donor element 112. As shown in FIG. 2C, this causes the rotation axis 130A of contact roller 130 to move along the direction of arrow 148A. FIG. 2C shows that contact roller 130 is rolled on the imaged donor element 112 while imaged donor element 112 and substrate 110 remain positioned in their layered configuration.

The inventors have surprisingly determined that rolling a roller such as contact roller 130 on the imaged donor element 112 can be used to reduce the presence of artifacts such as edge discontinuities when imaged donor element 112 is subsequently removed from substrate 110. In particular, the inventors have discovered that rolling the imaged donor element 112 prior to its removal from substrate 110 can lead to a reduced fracturing of the donor material at the edges of imaged features, especially when donor element 112 is peeled from substrate 110. Although the inventors do not want to be bound by any particular theory, one possible cause for the improved visual characteristics of the formed images may arise from the presence of “micro-slippage” between imaged donor element 112 and substrate 110 as contact roller 130 is rolled on imaged donor element 112. It is to be understood, however, that additional or alternate causes may lead to the improved image characteristics as provided by the invention.

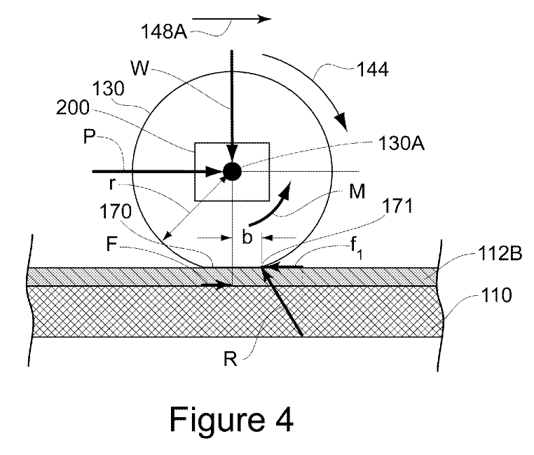

FIG. 4 illustrates a schematic force diagram representing the motion of contact roller 130 as it rolls on supported donor element 112. With the exception of interface force F, all of the forces and moments are shown acting on contact roller 130. The forces acting on contact roller 130 include the load W exerted on contact roller 130. Load W can include a force exerted on contact roller 130 by chassis-position actuators 131. Force P represents the force required to move contact roller on the surface of the supported donor element 112 along direction of arrow 148A and in this illustrated embodiment is provided by chassis-position actuators 131. Couple M represents the frictional resistance or drag that is exerted on contact roller and opposes rotational direction of arrow 144. This drag can be created by various factors including the frictional resistance of the bearings of contact roller coupling 138 (not shown in FIG. 4). Contact roller 130 can include a compliant surface which can lead to various deformations at the point of contact between the roller 130 and the supported donor element 112. Such a deformation is shown at area 170 in FIG. 4. These deformations cause contact between contact roller 130 and donor element 112 to take place not at a single contact line but rather, over a certain area which can give rise to “rolling resistance”. Although the deformation shown in FIG. 4 is confined to contact roller 130, it is to be understood that deformation can also occur on the surface that the roller rolls along. FIG. 4 shows that the resultant of the forces applied over this area by supported donor element 112 on contact roller 130 is reaction force R which is applied at point 171. Point 171 is not located directly underneath the rotation axis 130A, but slightly in front of it. Point 171 is displaced from center of rotation 172 by distance b. Distance b is known in the art as the coefficient of rolling resistance. It is to be noted however that b is not a dimensionless coefficient since it is expressed in units of length. A component of reaction force R is the friction force f₁ between contact roller 130 and supported donor element 112. An interface force F also exists between donor element 112 and substrate 110. The radius of contact roller 130 is shown as “r”.

A summation of the moments acting on contact roller 130 about point 171 may be expressed by the following relationship (i.e. assuming the roller is moving with a constant speed):

P*r≈M+(W*b). (1)

A summation of forces acting on contact roller 130 along a direction of movement 148A of contact roller 130 may be expressed by the following relationship (i.e. assuming the roller is moving with a constant speed):

f₁=P. (2)

By recombining relationships (1) and (2), the following relationship can be established:

f₁=P≈(M+(W*b))/r. (3)

When these various parameters combine to cause friction force f₁ to exceed interface force F, some slippage may occur between donor element 112 and substrate 110. Small amounts of slippage referred to as micro-slippage may occur in regions of the donor element-to-substrate interface in the vicinity of the contact area. Interface force F is dependant on various factors which can include the hold down force between imaged donor element 112 and substrate 110 (e.g. an applied suction between donor element 112 and substrate 110), load W and various frictional parameters pertaining to the donor element-to-substrate interface. Other factors can include the shear forces that must be overcome to shear the donor material at the boundaries of various image features that are formed. When friction force f₁ is sufficiently large to overcome interface force F, donor material at the boundaries of imaged features may shear as friction force f₁ causes a localized shearing of imaged donor element 112 in the vicinity of the imaged feature boundaries. The localized shearing of the donor material may in turn reduce the amount of fracturing that can occur at the imaged feature boundaries when imaged donor element 112 is peeled from substrate 110. The inventors have found that rolling contact roller 130 across imaged region 112A noticeably promotes reduction of artifacts along the edges of the features formed in imaged region 110B of substrate 110 when imaged donor element 112 is removed from substrate 110.

Friction force f₁ may be increased to desired levels in various ways. Relationship (3) suggests that friction force f₁ can be increased by increasing load W or by employing contact rollers 130 having a reduced radius r. This can be done in various embodiments of the invention while in other embodiments of the invention various factors may limit the extent of allowable changes associated with these parameters. For example, excessive increases in load W may lead to contact stresses sufficient for damaging the donor material that has been transferred to substrate 110 thereby reducing the visual quality of the final image. Reducing the size of contact roller 130 may lead to undesirable deflections in the roller which can adversely impact the ability of contact roller 130 to uniformly roll over donor element 112. Reducing the size of contact roller 130 may also promote the aforementioned contact stress problems. Increase in load W may also increase interface force F.

In some example embodiments of the invention, contact roller 130 includes material or geometry that gives rise to a coefficient of rolling resistance b sufficient to achieve a desired image quality once the imaged donor element 112 is peeled from substrate 110. In some example embodiments of the invention, various frictional attributes between contact roller 130 and donor element 112 are adjusted to achieve a desired image quality. These frictional attributes can include adjusting material properties of one or both of contact roller 130 and donor element 112 to change associated coefficients of friction, for example.

Relationship (3) also suggests that friction force f₁ can also be increased by increasing the drag created by couple M. In the example embodiment of the invention shown in FIG. 2C, a brake 200 is employed to selectively adjust the drag on contact roller 130 to a desired level suitable for reducing artifacts such as the aforementioned edge discontinuities. Brake 200 is controlled by signal 201 to selectively apply a desired amount of drag to contact roller 130 as it is rolled over the surface of supported donor element 112. Brake 200 can be actuated by various actuators controlled by signal 201. The use of brake 200 can be particularly advantageous especially in applications in which contact roller 130 performs various different functions. Unlike some of the other parameters, the amount of drag applied to contact roller as required by a specific function can be easily tailored by appropriately activating brake 200 in accordance with the desired amount of drag required by that function. In this regard, brake 200 can be selectively activated as per the requirements of a particular function required of contact roller 130 thereby allowing contact roller 130 to perform different functions. In this illustrated embodiment of the invention, one of the functions of brake 200 is to selectively apply a sufficient amount of drag to contact roller 130 during step 320 to improve visual qualities of the formed imaged when imaged donor element 112 is subsequently removed from substrate 110. In various example embodiments of the invention, contact roller 130 is controlled to roll along a rolling direction that is substantially parallel to a direction that donor element 112 is subsequently peeled along to remove donor element 112 from substrate 110.

In some example embodiments of the invention, debris created by the braking action of brake 200 is not desired in particular applications (e.g. the formation of color filters in clean room environments). In these embodiments, brakes 200 that minimize the generation of such debris are preferred. Such brakes can include magnetic particle brakes and hysteresis brakes, for example.

In the illustrated embodiment, brake 200 is selectively controlled to apply rotational drag to contact roller 130. In other example embodiments of the invention, drag can be selectively used in other ways. For example, contact roller 130 can be a driven roller which is controlled to move chassis 136 as the contact roller 130 is driven to roll over imaged donor element 112. Various actuators can be controlled to selectively apply forces that restrict the movement of chassis 136. Various actuators can be controlled to selectively apply linear drag forces to chassis 136.

Suitable parameters for the rolling of contact roller 130 over supported donor element 112 will typically depend on various factors which can include the material properties of the substrate of donor element 112, the donor material, and substrate 120. Parameters such as applied drag are typically determined by a trial and error process.

In the illustrated embodiment of the invention, contact roller 130 is rolled along a rolling direction (i.e. the direction of arrow 148A in FIG. 2C) that is substantially parallel to direction of movement that support 101 was conveyed along during the image forming step 300. In this example embodiment, the rolling direction is substantially parallel to main-scan axis 42. In various example embodiments of the invention, the rolling direction can be substantially parallel to a direction that the radiation beams were scanned along during the imaging of donor element 112. In various example embodiments of the invention, patterns of features can be imaged during step 300. The imaged features in the patterns can repeat along one or more directions and contact roller 130 can be controlled to roll along a rolling direction that is substantially parallel to one of these one or more directions. In various example embodiments of the invention, patterns of continuous stripe features or interrupted stripe features can be imaged during step 300. Contact roller 130 can be controlled to roll along a rolling direction that is substantially parallel to a direction in which the continuous or interrupted stripe features extend along. In some example embodiments of the invention, the various imaged features formed in step 300 may be formed with an orientation that is selected in accordance with a particular rolling direction that contact roller 130 is subsequently rolled along. A particular orientation of the imaged features can be selected to facilitate improved visual qualities in the final image when the contact roller 130 is rolled on donor element 112 and donor element 112 is subsequently removed from substrate 110.

Imaged donor element 112 is removed from substrate 110 in step 330. In this illustrated embodiment, donor element 112 is removed after contact roller 130 has rolled across imaged region 112B to un-imaged region 112A in the vicinity of edge portion 115B. As shown in FIG. 2D signal 135 causes take-up roller axis-position actuator 133 to move take-up roller 132 into the vicinity of imaged donor element 112. Preferably, take-up roller 132 moves into the vicinity of non-imaged region 112A of donor element 112 at a location that is further from imaged region 112B than the location of contact roller 130. In this illustrated embodiment, take-up roller 132 moves into the vicinity of portion 113 of non-imaged region 112A. In currently preferred embodiments, take-up roller 132 moves into the vicinity of portion 113 at a location which at least partially overlies stand 118. In some embodiments, take-up roller 132 moves into the vicinity of non-imaged region 112A at a location that is spaced further from the edge of substrate 110 than suction features 120 which secure donor element 112 to substrate 110.

When take-up roller 132 makes contact with donor element 112, controller 108 uses signal 145 to cause suction source 143 to apply suction through suction features 134. The application of suction through suction features 134 causes a portion of non-imaged region 112A (including edge portion 115B) to adhere to take-up roller 132 (i.e. suction features 134 secure a portion of non-imaged region 112A to take-up roller 132). In some embodiments, take-up roller 132 contacts donor element 112 in non-imaged region 112A and suction is applied directly to secure donor element 112 to take-up roller 132. In other embodiments, take-up roller 132 need not contact donor element 112 before suction is applied. In such embodiments, when suction is applied through suction features 134, a portion of donor element 112 may be drawn toward take-up roller 132 before being secured thereto. In some embodiments, controller 108 may turn off or reduce the suction applied by suction features 120 prior to or during the application of suction through suction features 134.

In some embodiments, suction features 134 are located in one or more known locations on the cylindrical surface of take-up roller 132. In such embodiments, controller 108 preferably uses signal 141 to operate take-up roller rotational actuator 139 in a “position mode”. In position mode operation, controller 108 uses a control technique which causes actuator 139 to move take-up roller 132 at any velocity (within its controllable velocity range) to achieve a desired position. As illustrated in FIG. 2D, the desired position of take-up roller 132 is a position where suction features 134 are located proximate to donor element 112. In the illustrated embodiment, take-up roller 132 is shown as having suction features in only one circumferential location on its cylindrical surface. Those skilled in the art will appreciate that in other embodiments, take-up roller 132 may comprise suction features at a plurality of circumferential locations on its cylindrical surface.

FIG. 2E shows that once edge portion 115B of donor element 112 is secured to the cylindrical surface of take-up roller 132, controller 108 uses signal 135 to cause take-up roller axis-position actuator 133 to move take-up roller 132 away from substrate 110 (i.e. in a direction that has at least a component in the direction of arrow 146). As can be seen by comparing FIGS. 2D and 2E, take-up roller axis-position actuator 133 causes movement of take-up roller 132 with respect to chassis 136 and with respect to contact roller 130 while chassis 136 and contact roller 130 remain in the same positions. Edge portion 115B of donor element 112 and possibly some of non-imaged region 112A move away from support 101 when take-up roller 132 moves in this manner.

As shown in FIG. 2E, contact roller 130 preferably remains in contact with, and may exert force against, donor element 112. Consequently, a portion of donor element 112 on one side of contact roller 130 (i.e. the side away from take-up roller 132) remains in contact with substrate 110 while a portion of donor element 112 on the opposite side of contact roller 130 (i.e. the same side as take-up roller 132) peels away from substrate 110 and bends around the circumferential surface of contact roller 130. Characteristics of contact roller 130 (e.g. its diameter and/or the material which forms its cylindrical surface) and/or characteristics of the manner in which contact roller 130 contacts donor element 112 (e.g. the force and/or pressure of such contact) can be used to control the effective area of contact between donor element 112 and substrate 110 immediately prior to peeling. In some embodiments, the effective area of contact between contact roller 130 and donor element 112 is less than 10% of the circumferential surface area of contact roller 130. In other embodiments, this ratio is less than 5%. In some embodiments, the force applied between contact roller 130 and donor element 112 is less than the force of gravity acting on contact roller 130 (i.e. chassis 136 supports some of the weight of contact roller 130).

The movement of take-up roller 132 away from substrate 110 may also comprise movement of take-up roller 132 in one or more directions that are tangential to substrate 110. For example, take-up roller axis position actuator 133 may cause take-up roller 132 to move on a curved path. During the movement of take-up roller 132 away from substrate 110, controller 108 may use signal 141 to cause take-up roller rotational actuator 139 to pivot take-up roller 132 about its axis 132A. Such pivotal motion of take-up roller 132 can be used to take-up any slack in the portion of imaged donor element 112 which has been peeled from substrate 110 or to otherwise track a desired tension on this portion of imaged donor element 112. During this period, controller 108 may use signal 141 to control take-up roller rotational actuator 139 in “torque mode”. In torque mode operation, controller 108 uses a control technique which causes actuator 139 to move take-up roller 132 at any velocity (within its controllable velocity range) to track a desired torque.

Those skilled in the art will appreciate that the amount of movement of take-up roller 132 by take-up roller axis-position actuator 133 may be varied to achieve a desired peel angle θ. In the illustrated embodiment, where contact roller 130 and take-up roller 132 are substantially the same size, peel angle θ will be the same as the angle between the rotational axes 130A, 132A of rollers 130, 132. In some embodiments, peel angle θ is less than thirty (30) degrees depending in part on the media (i.e. the donor material, substrate 110 and donor element 112). In currently preferred embodiments, peel angle θ is less than five (5) degrees.

Next, as shown in FIG. 2F, controller 108 uses signal 137 to cause chassis-position actuators 131 to move chassis 136 (including rollers 130, 132) in the direction of arrow 148B and uses signal 141 to cause take-up roller rotation actuator 139 to simultaneously rotate take-up roller 132 with respect to chassis 136 and support 101 in the direction of arrow 147. This simultaneous movement of chassis 136 and rotation of take-up roller 132 pulls donor element around contact roller 130 and peels donor element 112 from substrate 110. Contact roller 130 rotates in the direction of arrow 146 as it is rolled on imaged donor element 112 along a peeling direction (i.e. along the direction of arrow 148B. As shown in FIG. 2F, this rotation causes the rotation axis 130A of contact roller 130 to move along the direction of arrow 148B. In this illustrated embodiment, the direction of arrow 148B is opposite to the direction of arrow 148A that contact roller 130 was rolled along in step 320. In this illustrated embodiment, the peeling direction associated with the movement of contact roller 130 during step 330 is opposite to the rolling direction associated with the movement of contact roller 130 during step 320.

Preferably, during this part of the sheet peeling process, controller 108 uses signal 141 to operate take-up roller rotational actuator 139 in a “torque mode”, where controller 108 causes take-up roller 132 to rotate at any velocity (within its controllable velocity range) to achieve a desired torque. When take-up roller rotational actuator 139 operates in torque mode to track this desired torque, the peeling tension on donor element 112 is maintained relatively close to the desired peeling tension. In other embodiments, controller 108 uses signal 141 to operate take-up roller rotational actuator 139 in a “position mode” to track a position that is synchronized with the translational position of chassis 136.

As take-up roller 132 rotates in the direction of arrow 147 and translates in the direction of arrow 148B, donor element 112 is “spooled up” by (i.e. winds around the cylindrical surface of) take-up roller 132. Contact roller 130 remains in contact with the portion of donor element 112 which is still on substrate 110 and may apply a force against donor element 112. As discussed above, in the illustrated embodiment, contact roller 130 is an idler roller. Contact roller 130 prevents donor element 112 from separating prematurely from substrate 110 and ensures that donor element 112 is separated from substrate 110 at the desired peel angle θ.

In this illustrated embodiment of the invention, brake 200 is controlled to apply a different amount of drag to contact roller 130 as the contact roller is rolled on the surface of imaged donor element 112 during the separation and removal of imaged donor element 112 from substrate 110 than during the post imaging rolling sequence corresponding to step 320. That is, a plurality of relative movements between the rotation axis 130A of contact roller 130 and imaged donor element 112 and support 101 were enabled to cause contact roller to roll over imaged region 112B a plurality of times (i.e. in steps 320 and 330). During one of the plurality of relative movements, donor element 112 was removed from substrate 110 by the peeling method described. In this illustrated embodiment, brake 200 was selectively controlled to apply different amounts of drag to contact roller 130 during each of the relative movements. Different amounts of the selectively applied drag can include larger or smaller amounts of drag than the amount of drag that was applied in step 320. In this illustrated embodiment of the invention, brake 200 is controlled to apply less drag during step 330 than during step 320. In this embodiment, substantially no additional drag to contact roller 130 was applied by brake 200 during the removal of donor element 112 from substrate 110. It is to be noted however, that brake 200 may provide some form of minimal drag even when un-actuated. Brake 200 can be actuated to apply varying amounts of drag for varying durations to contact roller 130 and these amounts and durations can vary in accordance with a requirement of an application involving contact roller 130. Brake 200 can be controlled to selectively apply different amounts of drag to contact roller 130 at various positions along a path that contact roller 130 is rolled along.

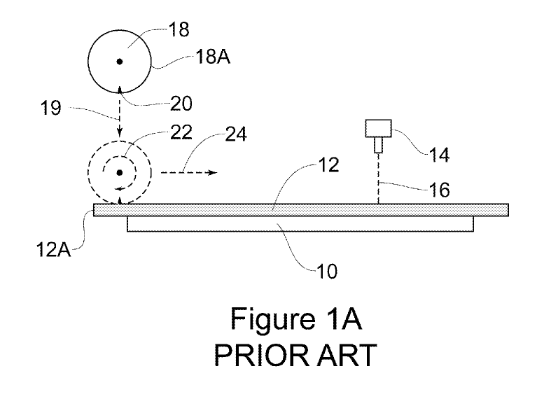

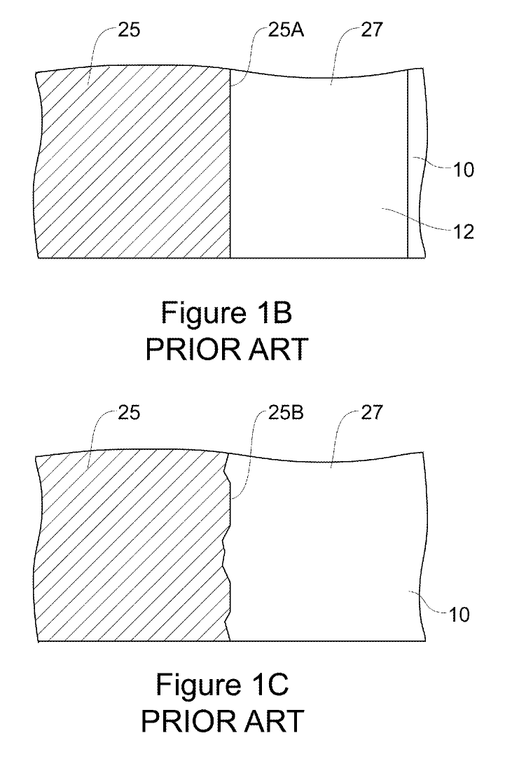

The simultaneous rotation and translation of both contact roller 130 and take-up roller 132 during the sheet peeling process also prevents a “print-through” effect. Print-through effects can arise when a donor element is wrapped around a roller as the roller is translated to peel the donor element from an underlying substrate (i.e. see FIG. 1A). Since the media edge can have a non-negligible thickness, the edge of the media that is initially secured to the roller can cause a portion of the unpeeled donor element to exhibit a discontinuity when the secured edge is rolled over it. Since take-up roller 132 is spaced-apart from substrate 110, the image imparted onto substrate 110 is unaffected when the portion of donor sheet 112 being wound onto take-up roller 132 overlaps edge portion 115B. The change in thickness caused by the edge portion 115B of donor element 112 does not impact the image imparted onto substrate 110.

As contact roller 130 approaches the edge portion 115A of donor element 112, controller 108 may use signal 137 to cause chassis-position actuator 131 to move chassis 136 away from donor element 112 and may use signal 141 to cause take-up roller rotational actuator 139 to rotate take-up roller 132 so as to take-up the “tail” of donor element 112. Controller 108 may operate take-up roller rotational actuator 139 in a position mode during this portion of the donor element 112 removal process.

Once donor element 112 has been removed from substrate 110, a second donor element 112 (e.g. a donor element 112 of a different color) can be positioned on substrate 110 and a method similar to that taught by the invention can be employed to further image the second donor element 112 and remove the second donor element 112 when it has been imaged. In this illustrated embodiment, substrate 110 is removed from support 101 in step 340. Donor element removal apparatus 129 need not remove substrate 110 from support 101 as other mechanisms as known in the art can be employed. In this illustrated embodiment of the invention, substrate 110 is not removed from support 101 during any of the plurality of relative movements between the rotation axis 130A of contact roller 130 and imaged donor element 112 that were enabled to cause contact roller to roll over imaged region 112B a plurality of times in preceding steps.

“Pre-rolling” the imaged donor element 112 prior to the removal of imaged donor element 112 from substrate 110 can be used to reduce artifacts that can arise when donor element 112 is removed from substrate 110. In particular, the amount of the donor material that remains transferred to the surface of the substrate 110 when the imaged donor element 112 is peeled from the substrate can be adjusted by pre-rolling contact roller 130 on imaged donor element 112 prior to its removal. Artifacts such as edge discontinuities can be reduced by this adjustment of the amount of donor material that remains transferred to the surface of the substrate. In this regard, the inventors have found that variations in the amount and distribution of donor material that is intended to be transferred to a particular region of substrate 110 can be reduced by rolling contact roller 130 on donor element 112 prior to its removal from substrate 110 especially when the particular region is in the vicinity of an edge portion of a feature formed on substrate 110.

Although in this illustrated embodiment, the same contact roller 130 was used in both the pre-rolling steps and the peeling steps, one skilled in the art will quickly ascertain that different rolling members can be used in each of these steps. Contact roller 130 can include a roller whose function is dedicated solely to the pre-rolling aspects of the invention.

Various embodiments of the invention have been described in terms of manufacturing color filters for various displays. In some example embodiments of the invention, the displays can be LCD displays. In other example embodiments of the inventions, the displays can be organic light-emitting diode (OLED) displays. OLED displays can include different configurations. For example, in a fashion similar to LCD display, different color features can be formed into a color filter used in conjunction with a white OLED source. Alternatively, different color illumination sources in the display can be formed with different OLED materials in various embodiments of the invention. In these embodiments, the OLED based illumination sources themselves control the emission of colored light without necessarily requiring a passive color filter. OLED materials can be transferred to suitable media. OLED materials can be transferred to a receiver element with laser-induced thermal transfer techniques.

While the invention has been described using as examples applications in display and electronic device fabrication, the methods described herein are directly applicable to other applications including those used in biomedical imaging for lab-on-a-chip (LOC) fabrication. The invention can have application to other technologies, such as medical, printing and electronic fabrication technologies.

The invention has been described in detail with particular reference to certain preferred embodiments thereof, but it will be understood that variations and modifications can be effected within the spirit and scope of the invention.

### PARTS LIST

10 substrate
12 donor element
12A edge
14 lasers
16 laser beams
18 roller
18A circumferential surface
19 arrow
20 suction features
22 arrow
24 arrow
25 imaged region
25A imaged edge
25B edge
27 non-imaged region
42 main-scan axis
42A forward direction
42B reverse direction
44 sub-scan axis
44A away direction
44B home direction
100 apparatus
101 support
102 imaging head
103 imaging electronics
104 image data
105 support
108 controller
109 motion system
110 substrate
110A non-imaged region
110B imaged region
112 donor element
112A non-imaged region
112B imaged region
113 portions
114 channels
115A donor element edge portion
115B donor element edge portion
116 radiation beams
118 stands
120 suction features
122 space
129 sheet removal apparatus
130 contact roller
130A rotation axis
131 chassis-position actuators
132A rotation axis
132 take-up roller
133 take-up roller axis-position actuator
134 suction feature
135 signal
136 chassis
137 signal
138 contact roller coupling
139 take-up roller rotational actuator
140 take-up roller coupling
141 signal
143 suction source
144 arrow
145 signal
146 arrow
147 arrow
148A arrow
148B arrow
170 area
171 point
200 brake
201 signal
300 step
310 step
320 step
330 step
340 step
W load
P force
M couple
b coefficient of rolling resistance
R reaction force
f₁ friction force
f interface force
r radius
θ peel angle

1. A method for imaging a media, comprising:
providing a support adapted for supporting a substrate and the media in a layered configuration;
operating an imaging head to image the media by directing radiation beams towards a surface of the imaged media while effecting relative movement between the imaging head and the support;
bringing a roller into contact with the imaged media, wherein the roller is rotatable about an axis of rotation;
effecting relative movement between the axis of rotation of the roller and the support to cause the roller to roll on regions of the surface of the imaged media impinged by the radiation beams; and
removing the imaged media from the substrate after rolling the roller on the regions of the surface of the imaged media impinged by the radiation beams.

2. A method according to claim 1, wherein after the imaged media is removed from the substrate, the method further comprises supporting an additional media and the substrate on the support; imaging the additional media while effecting relative movement between the imaging head and the support; and removing the imaged additional media from the substrate while effecting relative movement between the axis of rotation of the roller and the support.

3. A method according to claim 1, wherein the roller is brought into contact with an un-imaged region of the surface of the imaged media, the un-imaged region corresponding to a region of the surface of the imaged media that is not impinged by the radiation beams.

4. A method according to claim 3, wherein the un-imaged region includes an edge portion of the media, and wherein effecting the relative movement between the axis of rotation of the roller and the support causes the roller to roll on the surface of the imaged media along a direction that leads away from the edge portion.

5. A method according to claim 1, wherein the roller is an idler roller.

6. A method according to claim 1, wherein removing the imaged media from the substrate comprises peeling the imaged media from the substrate.

7. A method according to claim 6, comprising effecting additional relative movement between the axis of rotation of the roller and the support to cause the roller to roll on a portion of the surface of the imaged media while peeling the imaged media from the substrate.

8. A method according to claim 6, comprising wrapping a portion of the imaged media over a portion of a cylindrical surface of the roller while peeling the imaged media from the substrate.

9. A method according to claim 6, comprising providing a contact roller adapted to roll on the surface of the imaged media, the method further comprising wrapping a portion of the imaged media over a portion of a cylindrical surface of the contact roller while peeling the imaged media from the substrate.

10. A method according to claim 1, comprising providing a take-up roller adapted to spool a portion of the imaged media while not rolling the take-up roller on the surface of the media, the method further comprising spooling the portion of the imaged media onto the take-up roller while removing the imaged media from the substrate.

11. A method according to claim 9, comprising effecting the relative movement between the axis of rotation of the roller and the support to cause the roller to roll along a rolling direction on the regions of the surface of the imaged media impinged by the radiation beams, and effecting relative movement between the contact roller and the support to cause the contact roller to roll along a peeling direction on a portion of the surface of the imaged media while peeling the imaged media from the substrate, wherein the peeling direction is substantially parallel to the rolling direction.

12. A method according to claim 11, wherein the rolling direction and the peeling direction are opposite directions.

13. A method according to claim 1, wherein the imaging head is operated to image the media by scanning the radiation beams over the surface of the imaged media along a scan direction, and the method further comprises effecting the relative movement between the axis of rotation of the roller and the support to cause the roller to roll on the regions of the surface of the imaged media impinged by the radiation beams along a rolling direction that is substantially parallel to the scan direction.

14. A method according to claim 1, comprising moving one of the support and the imaging head along a conveyance direction while imaging the media, wherein effecting the relative movement between the axis of rotation of the roller and the support causes the roller to roll on the regions of the surface of the media impinged by the radiation beams along a rolling direction that is substantially parallel to the conveyance direction.

15. A method according to claim 1, comprising selectively applying drag to the roller while rolling the roller on a portion of the surface of the imaged media.

16. A method according to claim 1, comprising providing a brake adapted to selectively apply drag to the roller while rolling the roller on a portion of the surface of the imaged media.

17. A method according to claim 16, wherein the brake is one of a magnetic particle brake and a hysteresis brake.

18. A method according to claim 1, wherein the media is a donor element, and the method further comprises operating the imaging head to direct the radiation beams towards the donor element to transfer donor material from the donor element to the substrate to form a striped feature on the substrate, wherein the striped feature extends along a direction that is substantially parallel to a direction that the roller is rolled along on the surface of the imaged media while effecting the relative movement between the axis of rotation of the roller and the support to cause the roller to roll on the regions of the surface of the media impinged by the radiation beams.

19. A method according to claim 1, comprising removing the substrate from the support after removing the imaged media from the substrate.

20. A method for imaging a media, comprising:
providing a support adapted for supporting a substrate and the media in a layered configuration;
operating an imaging head to emit radiation beams towards the media to image the media while the media and the substrate are in the layered configuration;
bringing a roller into contact with a surface of the imaged media;
selectively applying drag to the roller while rolling the roller on the surface of the imaged media; and
removing the imaged media from the substrate.

21. A method according to claim 20, comprising selectively applying rotational drag to the roller while rolling the roller on the surface of the imaged media.

22. A method according to claim 20, comprising providing a brake operatively connected to the roller, wherein the brake is adapted to selectively apply the drag to the roller while rolling the roller on the surface of the imaged media.

23. A method according to claim 20, comprising selectively activating an actuator to cause the drag to be selectively applied to the roller while rolling the roller on the surface of the imaged media.

24. A method according to claim 20, wherein removing the imaged media from the substrate comprises peeling the imaged media from the substrate.

25. A method according to claim 20, comprising rolling the roller on the surface of the imaged media while removing the imaged media from the substrate.

26. A method according to claim 24, comprising peeling the imaged media from the substrate after rolling the roller on the surface of the imaged media.

27. A method according to claim 20, comprising rolling the roller along a plurality of different directions on the surface of the imaged media, and selectively applying different amounts of drag to the roller as the roller is rolled on the surface.

28. A method according to claim 24, comprising rolling the roller on the surface of the imaged media while maintaining the imaged media and the substrate in the layered configuration, and rolling the roller on the surface of the imaged media while peeling the media from the substrate.

29. A method according to claim 28, wherein selectively applying drag to the roller while rolling the roller on the surface of the imaged media comprises applying a different amount of drag to the roller as the roller rolls on the surface of the imaged media while maintaining the imaged media and the substrate in the layered configuration than while the roller rolls on the surface of the imaged media while peeling the imaged media from the substrate.

30. A method according to claim 28, wherein selectively applying drag to the roller while rolling the roller on the surface of the imaged media comprises applying a greater amount of drag to the roller as the roller rolls on the surface of the imaged media while maintaining the imaged media and the substrate in the layered configuration than while the roller rolls on the surface of the imaged media while peeling the imaged media from the substrate.

31. A method according to claim 24, comprising providing a contact roller adapted to roll on the surface imaged media, the method further comprising wrapping a portion of the imaged media over a portion of a surface of the contact roller while peeling the imaged media from the substrate.

32. A method according to claim 24, comprising providing a take-up roller adapted to spool a portion of the imaged media while not rolling the take-up roller on the surface of the imaged media, the method further comprising spooling the portion of the imaged media onto the take-up roller while peeling the imaged media from the substrate.

33. A method according to claim 20, comprising imaging the media with a thermal transfer process.

34. A method according to claim 20, wherein the roller is an idler roller.

35. A method according to claim 20, comprising removing the substrate from the support after removing the imaged media from the substrate.

36. A method for imaging a donor element, comprising:
supporting a substrate on a support;
positioning the donor element on the substrate after supporting the substrate on the support;
operating an imaging head to image the donor element by directing radiation beams towards the donor element;
bringing a roller into contact with a surface of the imaged donor element, wherein the roller is rotatable about an axis of rotation;
effecting a plurality of relative movements between the axis of rotation of the roller and the imaged donor element to cause the roller to roll on one or more imaged regions of the imaged donor element a plurality of times;
removing the imaged donor element from the substrate during a relative movement of the plurality of relative movements between the axis of rotation of the roller and the imaged donor element; and
removing the substrate from the support after the imaged donor element is removed from the substrate, wherein the substrate is not removed from the support during any relative movement of the plurality of relative movements between the axis of rotation of the roller and the imaged donor element.

37. A method according to claim 36, wherein effecting the plurality of relative movements between the axis of rotation of the roller and the imaged donor element includes effecting relative movement between the axis of rotation of the roller and the support.

38. A method according to claim 36, wherein after the imaged donor element is removed from the substrate, the method comprises: positioning a second donor element on the substrate; imaging the second donor element with the imaging head; and removing the second donor element from the substrate while effecting relative movement between the axis of rotation of the roller and the imaged second donor element.

39. A method according to claim 36, wherein two relative movements of the plurality of relative movements between the axis of rotation of the roller and the imaged donor element cause the roller to roll along different directions on the one or more imaged regions of the imaged donor element.

40. A method according to claim 36, wherein two relative movements of the plurality of relative movements between the axis of rotation of the roller and the imaged donor element cause the roller to roll along opposite directions on the one or more imaged regions of the imaged donor element.

41. A method according to claim 36, comprising applying a different amount of drag to the roller as roller rolls on the one or more imaged regions of the imaged donor element during one relative movement of the plurality of relative movements between the axis of rotation of the roller and the imaged donor element than during another relative movement of the plurality of relative movements between axis of rotation of the roller and the imaged donor element.

42. A method according to claim 36, comprising applying a greater amount of drag to the roller as roller rolls on the one or more imaged regions of the imaged donor element during one relative movement of the plurality of relative movements between the axis of rotation of the roller and the imaged donor element than during another relative movement of the plurality of relative movements between axis of rotation of the roller and the imaged donor element.

43. A method according to claim 36, comprising providing a brake adapted to selectively apply drag to the roller while effecting the plurality of relative movements between the axis of rotation of the roller and the imaged donor element.

44. A method according to claim 36, wherein the roller is an idler roller.

45. Apparatus for imaging media, comprising:
a support adapted for supporting a substrate and the media in a layered configuration;
an imaging head adapted to emit radiation beams towards the media to image the media;
a roller;
a brake adapted to selectively apply drag to the roller;
a chassis adapted to support the roller such that the roller is rotatable relative to the chassis,
a controller configured to:
operate the imaging head to emit the radiation beams towards the media;
effect relative movement between the chassis and the support to bring the roller in the vicinity of the imaged media while the imaged media and the substrate are in the layered configuration;
effect a plurality of relative movements between the chassis and the support to cause the roller to roll on a surface of the imaged media a plurality of times; and
control the brake to selectively vary the drag applied to the roller between one relative movement of the plurality of relative movements between the chassis and the support and another relative movement of the plurality of relative movements between the chassis and the support.

46. Apparatus according to claim 45, wherein the imaged media is peeled from the substrate during a relative movement of the plurality of relative movements between the chassis and the support.

47. Apparatus according to claim 46, comprising providing a take-up roller, wherein the take-up roller is adapted to spool a portion of the imaged media while not rolling the take-up roller on the surface of the image media, and the controller is further configured to operate the take-up roller to cause a portion of the imaged media to be spooled onto the take-up roller while peeling the imaged media from the substrate.

48. An imaging method, comprising:
positioning donor element and a substrate in a layered configuration;
providing an imaging head adapted to image the donor element by directing radiation beams towards the donor element to transfer donor material from the donor element to a surface of the substrate to form a feature thereon;
bringing a roller into the vicinity of a surface of the imaged donor element;
peeling the imaged donor element from the substrate; and
prior to peeling the imaged donor element from the substrate, effecting relative movement between the roller and the imaged donor element to roll the roller on a region of the imaged donor element to adjust an amount of the donor material that remains transferred to the surface of the substrate when the imaged donor element is peeled from the substrate.

49. An imaging method according to claim 48, wherein effecting the relative movement between the roller and the imaged donor element to roll the roller on the region of the imaged donor element reduces edge discontinuities along the edge of the feature when the donor element is peeled from the substrate.

50. An imaging method according to claim 48, comprising providing a brake adapted to increase the amount of drag applied to the roller when the roller is rolled on the region of the imaged donor element to adjust an amount of the donor material that remains transferred to the surface of the substrate when the imaged donor element is peeled from the substrate.

51. An imaging method, comprising:
positioning donor element and a substrate in a layered configuration;
providing an imaging head adapted to image the donor element by directing radiation beams towards the donor element;
transferring donor material from the donor element to a surface of the substrate to form a feature thereon;
bringing a roller into the vicinity of a surface of the imaged donor element;
peeling the imaged donor element from the substrate; and
prior to peeling the imaged donor element from the substrate, effecting relative movement between the roller and the imaged donor element to roll the roller on a region of the imaged donor element to adjust an amount of the donor material that is transferred to the surface of the substrate when the imaged donor element is peeled from the substrate.
